(19) United States
(12) Patent Application Publication
(10) Pub. No.: US 2015/0352010 A1
(43) Pub. Date: Dec. 10, 2015

(54) PILL PACK

(71) Applicant: MARSOFTWARE LIMITED, Hampshire (GB)

(72) Inventors: Jimi SIMPSON, South Yorkshire (GB); David APPLEBY, Hampshire (GB)

(21) Appl. No.: 14/759,406

(22) PCT Filed: Dec. 19, 2013
(86) PCT No.: PCT/GB2013/053365

§ 371 Date: Jul. 6, 2015

(30) Foreign Application Priority Data
Jan. 3, 2013 (GB) 1300112.8

(51) Int. Cl. A61J 1/03; B65D 75/36; B65D 75/54; B65D 65/14

(52) U.S. Cl. CPC A61J 1/035; B65D 65/14; B65D 75/367; B65D 75/54

(57) ABSTRACT

Some aspects of the invention include a card for a MARS pill pack and tag. The card has a cut-out open to an edge of the card or an aperture spaced from edges of the card for receiving the tag, with contacts arrayed at one side at least of the cut-out or aperture. The card has at least one formation in the card at at least one other side of the cut out or a tag backing strip extending at a side of the aperture opposite from the one side, the formation(s) or the tag backing strip being provided to hold the tag against movement parallel to the card whereby tag contacts are retained in contact with the card contacts in use.

The present invention relates to a pill pack.

As used herein the term “pill” means a small object including a medicinal substance, the object intended m be taken orally by a patient. It includes tablets formed by moulding of the substance alone or with a carrier and capsules having powdered substance within a soluble shell, tablets and capsules being the two most common form of pill.

There are regulatory requirements as regards the keeping of medication administration records, referred to below as “MAR data”. Currently these are kept as manually written records, either physically written on paper records or electronically written to storage media.

For patients on complex, medication regimes—several pills a day and different pills at different times of day—it is well known for the pills to be dispensed by a pharmacy into trays often having an array of 28 compartments arrayed as four compartments per day and seven days worth of four daily compartments. For longevity of the pills, in particular to ensure against deterioration from damp, the compartments are generally sealed with an impermeable film adhered to lands around and between the compartments in the tray, which latter is conveniently a vacuum/pressure formed moulding. Once the pills have been dispensed into the compartments—also referred to as populating the tray—and the film sealed on, a card identifying the intended day and part of the day at which the pills should be taken can be added to the sealed tray. Indeed the card can be added before the tray is populated. The card can incorporate the compartment sealing film and adhesive for adhering to both sides of the lands between the compartments. The card has double the number of apertures as compartments in the tray. The compartments extend through one array of apertures in one piece of the card. A fold is provided to another piece of the card, having another array of apertures which are brought into register with the compartments, on folding of the card. A third piece of the card is folded over the compartments. The entire populated assembly may be referred to as a pill box.

It has been proposed to provide electric circuit tracks on the compartment closure and sealing film, together with a connection tail. The arrangement was to include a respective circuit for each compartment and intended to allow interrogation of the integrity of each compartment's circuit, whereby opening of the compartment and implied taking of the pills by the patient could be recorded.

One such proposal is disclosed in WO 2012/049446, in the Future Technology name, whose abstract is as follows:

The invention provides a seal that forms part of a container for storing and dispensing consumer products. The container can be used in place of conventional blister packs for the packaging of pills, tablets or capsules or multi-cavity containers for organising and storing mixed medication for subsequent dispensation according to a predefined dosage regimen. The container includes a tray having a generally planar top surface into which has been formed one or more discrete cavities for receiving the consumer products. The seal includes a cover film (1) having a pattern of electrically conductive tracks (14) that defines a circuit per cavity. Pre-formed lines of separation (4) define a removable portion (2) per cavity to retain the consumer products in that cavity until it is removed along its line of separation. Each removable portion (2) is attached to the remainder of the cover film (1) by a frangible bridge region defined by a gap in the associated pre-formed line of separation (4) and which provides a pathway for the associated circuit (22). The frangible bridge region is torn to break the associated circuit (22) when the removable portion (2) is released or removed so that the contents of the underlying cavity can be dispensed.

In practice, film of a thickness suitable tot use in this manner is so thin that reeling of it after printing onto it—typically screen printing—of conductive ink and coring the ink to produce the circuit tracks causes too much stretch of the film. The result is that registration of contacts in the tail with a complementary connector is difficult to achieve reliably.

In a parallel field, it is known to provide electric tracks on so called “blister packs”. A blister pack has a moulding such as the tray above, with a number of compartments usually factory filled with pills, and closed with a foil. Electric tracks have been provided on the foil. They have also be provided on a card carrying the blister pack. These packs have been used is drug trials to monitor that drugs are being taken on time. Such a blister pack is described in U.S. Pat. No. 4,616,316, whose abstract is as follows:

A medication compliance monitoring system consisting of a blister pack having an array of plastic blisters, defining compartments for medication, with a frangible non-conductive backing sheet having conductive traces behind the compartments which are respectively ruptured when the medication doses are removed. The blister pack is detachably connected to an electronic memory circuit via a multi-terminal male connector tab on the backing sheet, wired to the conductive traces, and a corresponding female connector with terminals wired to the electronic memory circuit. The electronic memory circuit addresses each individual trace periodically at a constant time interval over a predetermined extended period of time to determine if it is intact. The electronic memory circuit detects the ruptures and stores the time data thereof over said extended period of time. During the patient's follow-up visit . . . . In a typical embodiment there are 42 blisters whose associated conductive traces are addressed every 15 minutes over on extended time period which may be as much as 85 days.

The object of the present invention is to provide an improved pill pack.

As used herein a MARS pill pack and tag means:

stray having, an array of pill compartments

a film for sealing the compartments

a card adhered to the film and having:
an array of apertures complementary to the compartments array in the tray,
each aperture having an openable tab across the aperture, the tab being tearable to allow pill(s) to pass through the aperture,
a pattern of electrically conductive lines on the sheet to and from the tabs, each tab having a tab-crossing section of line whose electrical continuity is broken when the tab is torn open and
a series of contacts on the sheet, the contacts and the lines being so arranged that a unique circuit is provided for each aperture, from one contact to another via a respective tab-crossing section, whereby there is electrical continuity between the two contacts whilst the tab remains intact, the circuit being broken when the tear is torn, and

a tag having complementary contacts connected to the card contacts, the tag being for recording circuit opening on tab opening for taking of a pill by a patient.

According to a first aspect of the invention there is provided a card for a MARS pill pack and tag, the card having:

a cut-out open to an edge of the card or an aperture spaced from edges of the card for receiving the tag, with the contacts arrayed at one side at least of the cut-out or aperture and

at least one formation in the card at at least one other side of the cut out or a tag backing strip extending at a side of the aperture opposite front the one side, the formation(s) or the tag backing strip being provided to hold the tag against movement parallel to the card whereby the tag contacts are retained in contact with the card contacts in use.

Where a cut-out open to an edge and side formations are provided, the cut-out has at least one lateral dimension as one position spaced from the edge of the card, which is narrower than a lateral dimension at another position spaced further from the edge of the card, forming an overhung feature. In this case the tag is formed with a complementary feature whereby it is held onto the card. The card features can be engaged with the complementary tag features either by deformation and return to shape into the tag features or by resilient movement of a feature of the tag. The arrangement may be such that the tag is slid translationally into the cut-out or engaged with the contacts at an orientation out of parallel with the card and then tilted back parallel with the card.

Where an aperture is provided in the card, the engagement will normally be via an orientation out of parallel with the card and then tilted back parallel with the card.

Whilst auxiliary contacts could be provided at other sides of the aperture, they will normally be at the one side only. Preferably the card has a flap folded, double at the contact side. Whilst the tag can have its complementary contacts arranged to connect with the card contacts on one side only of the double fold, in which case cards contacts need not extend onto the flap, preferably the tag has its contacts arranged to connect with the card contacts on both sides of the double fold, with the card contacts extending onto the flap.

Preferably the tag backing strip also has a double folded flap. This strengthens the tag backing strip. Further, where, as is expected to be the norm, the tag and the aperture are rectangular, the other two sides of the aperture also have double folded flaps.

In preferred embodiments, the card itself is folded double to be adhered not only to the sealing film but also as a backing sheet to the tray on the side thereof opposite from the sealing film, i.e. at lands between the individual compartments, with the compartments extending through cut-outs in the backing sheet portion of the card. In these embodiments, the folded double flaps are folded onto, and adhered onto, the backing sheet, whereby three thicknesses of card are present at the extent of the folded double flaps.

Whilst the card can be thinner than the range of thicknesses commonly referred to as card, especially since, at least as in the preferred embodiment, the card is folded double and adhered together sandwiching lands of the tray, the card is preferably of a thickness commonly referred to as card.

The contacts could be spaced from an edge of the card, but they preferably extend to it as a linear series, particularly where contacts extend onto a folded double flap. Conveniently the card edge having the contacts has a pair of positioning features for determining the position of a connector to the contacts to ensure one for one contact of the card contacts with contacts in the connector. The card edge can be an external edge or an internal edge, i.e. an edge of an aperture in the card.

A pair of lines to and from each tab-crossing line section can be unique and have a unique pair of contacts. However, normally, one of the lines for each tab is connected in common to a single common contact, in the manner of an earth/ground return line; whilst the other line and its contact is unique to each tab. An arrangement where the apertures are arrayed rectangularly with all the columns having respective lines to one side of the tab-crossing line sections and all the rows having respective lines to the other sides of the tabs/sections can be envisaged. Whilst such arrangement is advantageous in economy of contacts, it is topologically awkward to achieve, at least without two layers of lines, insulated from each other by a printed dielectric or other insulating layer and interconnected as requited via apertures in the dielectric or other insulating layer. Further, the lines could be provided on opposite sides of the card, but connections through the card are topologically awkward. Further, layers of conductive lines insulated by a printed dielectric or other insulating layer and interconnected via apertures in the dielectric or other insulating layer could be provided to both sides of the card, to utilise the pins of a double sided connector.

Preferably, the lines are arrayed symmetrically with respect to a central, common return line.

The card can have other conductive lines and respective contacts for other openable contacts in the card, such as a push-out disc having a disc-crossing line section, the disc being usable to indicate by its removal that the pills are to a new prescription for instance or that a carer has correlated the prescribed pills with the patient for whom they were prescribed and connected that person's connector to the card.

In another envisaged use, a dispensing pharmacist pushes out a number of discs to indicate the week of typically a four week medication cycle, thereby

The conductive lines can to be applied to either side of the card, or indeed conceivably both. However in the preferred embodiment they are applied to the same side of the card as graphic printing information. This is advantageous in that the card can have the lines printed and the graphics printed in a single printing operation to one side of the card.

Whilst it can be envisaged that the tray's compartments, could be closed by application of a separate film over pills populated in the tray, normally the film will be pre-applied to the card across the apertures, preferably with further adhesive for adhering the card to the tray pre-applied and initially covered by a release paper.

The tabs can be rendered tearable by means of the card being thin. However, they are preferably provided with one or more narrow portions and/or partially cut through and/or perforated portion(s) at adjacent parts of the card. Further the tabs may be two part with a narrowing or partially cut or perforated portion between the parts. The parts can otherwise be plainly or creasedly connected to adjacent parts of the card. Alternatively, partial cutting and/or perforations can be provided to the adjacent parts. The common feature of all these arrangements is that the conductive tab-crossing line section for the aperture crosses the tearable, partially cut or perforated portion whereby on tearing the line's continuity is broken.

Conveniently, the compartment closure film is pre-applied to the card across the apertures and the tabs. In common with the arrangement described in the fourth paragraph hereof above, the card can have two apertured pieces interconnected at a fold. The piece not having the tabs and closure film receives the individual compartments of the tray having them; whilst the film and tabs close over the compartments once these have been populated with pills when the two pieces of card are folded together. Conveniently both the tab-less piece and the closure film on the tabbed piece are have adhesive pre-applied for adhering to opposite sides of lands in the tray between the compartments. Again as in the prior arrangement, a third piece of card can be connected to the tabbed piece at an edge opposite from the compartment receiving piece. The third piece can also have adhesive pre-applied for receiving patient and prescription details. Prior to use the three pieces will have a release paper applied across their adhesive.

According to a second aspect, of the invention there is provided a tag for a MARS pill pack and tag, the tag having:
a one side having complementary contacts arranged along it and
an opposite side spaced from the one side for abutment against a backing strip of the card with its contacts connected to the complementary contacts or
another side formed with a formation complementary with a formation of the card for engagement therewith with its contacts connected to the complementary contacts.

Preferably, the opposite side and/or one or both other sides of the tag, (when it and the card are rectangular, which is normal although other shapes are possible) is/are stepped and/or have formations for locating against face of the card at the aperture. Normally the face will be double folded.

Again it is preferred that the tag has at least one sprung latch arranged at and movable inwards of the opposite side and/or one or both other sides of the tag on fitting to the tag to the card and to spring out on opposite side to the card from the tag formation.

According to a third aspect of the invention there is provided, for a MARS pill pack combination of:
a card having:
a cut-out open to an edge of the card or an aperture spaced from edges of the card for receiving the tag, with contacts arrayed at one side at least of the cut-out or aperture and
at least one formation in the card at at least one other side of the cut out or a tag backing strip extending at a side of the aperture opposite from the one side, the formation(s) or the tag backing strip being provided to hold the tag against movement parallel to the card whereby tag contacts are retained in contact with the card contacts in use,
a tray having an array of pill compartments and
a film for sealing the compartments.

According to a fourth aspect of the invention there is provided, for a populated MARS pill pack:
a card having:
a cut-out open to an edge of the card or an aperture spaced from edges of the card for receiving the tag, with contacts arrayed at one side at least of the cut-out or aperture and
at least one formation in the card at at least one other side of the cut out or a tag backing strip extending at a side of the aperture opposite from the one side, the formation(s) or the tag backing strip being provided to hold the tag against movement parallel to the card whereby tag contacts are retained in contact with the card contacts in use,
a tray adhered to the card having an array of pill compartments and populated with pills and
a film for sealing the compartments.

To help understanding of the invention, various specific embodiments thereof will now be described by way of example and with reference to the accompanying drawings, in which:

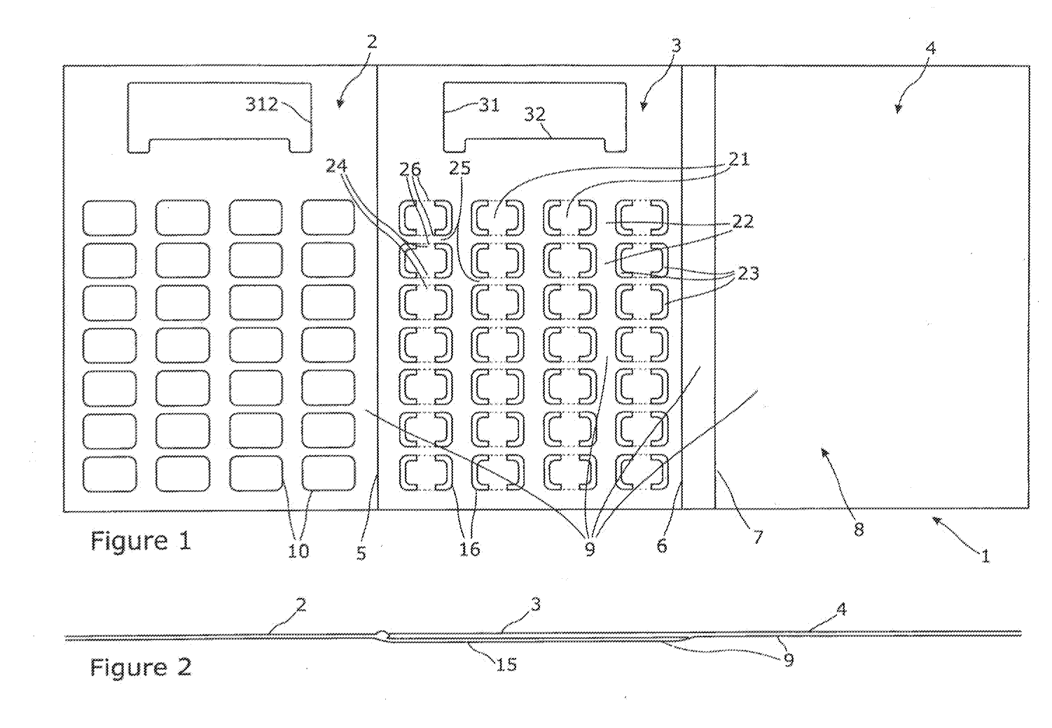

FIG. 1 is an inside surface view of a card for a pill pack in accordance with the invention:

FIG. 2 is a top view of the card of FIG. 1;

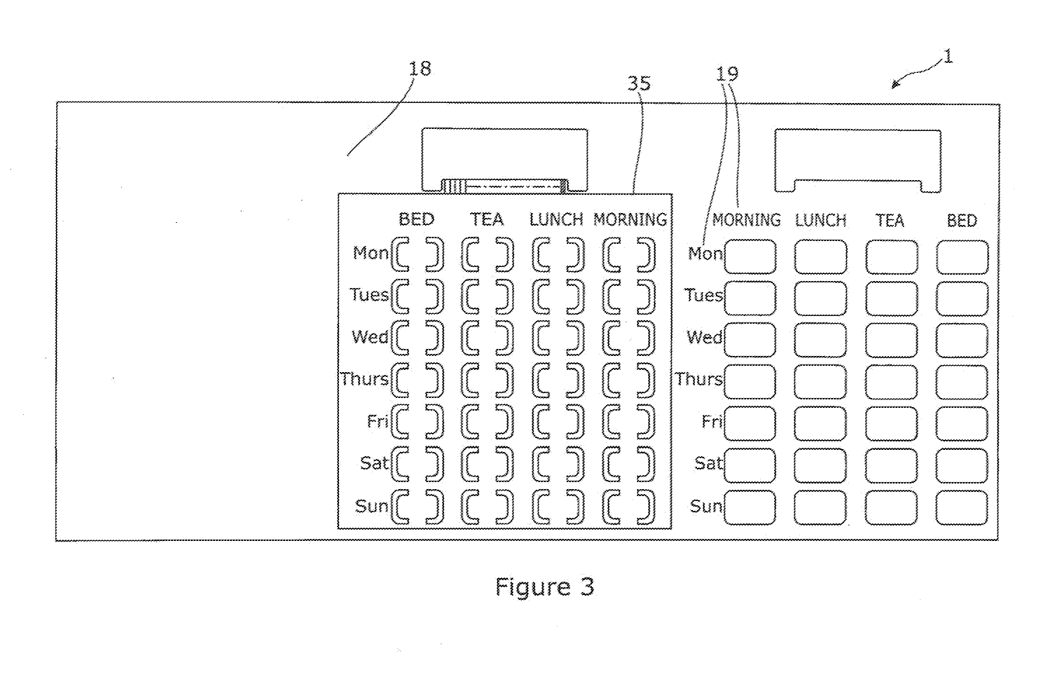

FIG. 3 is an outside surface view of the card of FIG. 1;

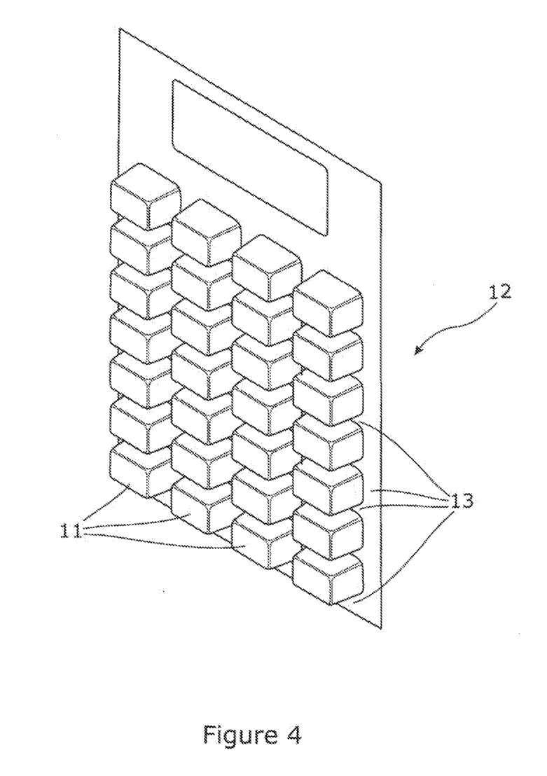

FIG. 4 is a perspective view of a pill tray for the card of FIG. 1;

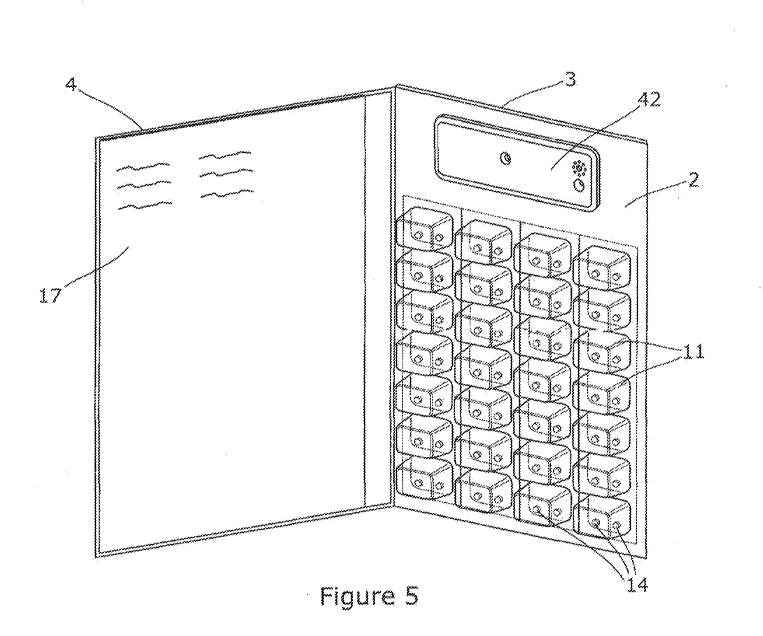

FIG. 5 is perspective view of the card of FIG. 1 and the pill tray of FIG. 4 assembled as a pill pack;

FIG. 6 is a conductive lines layout on the outside surface of a central piece of the card of FIG. 1;

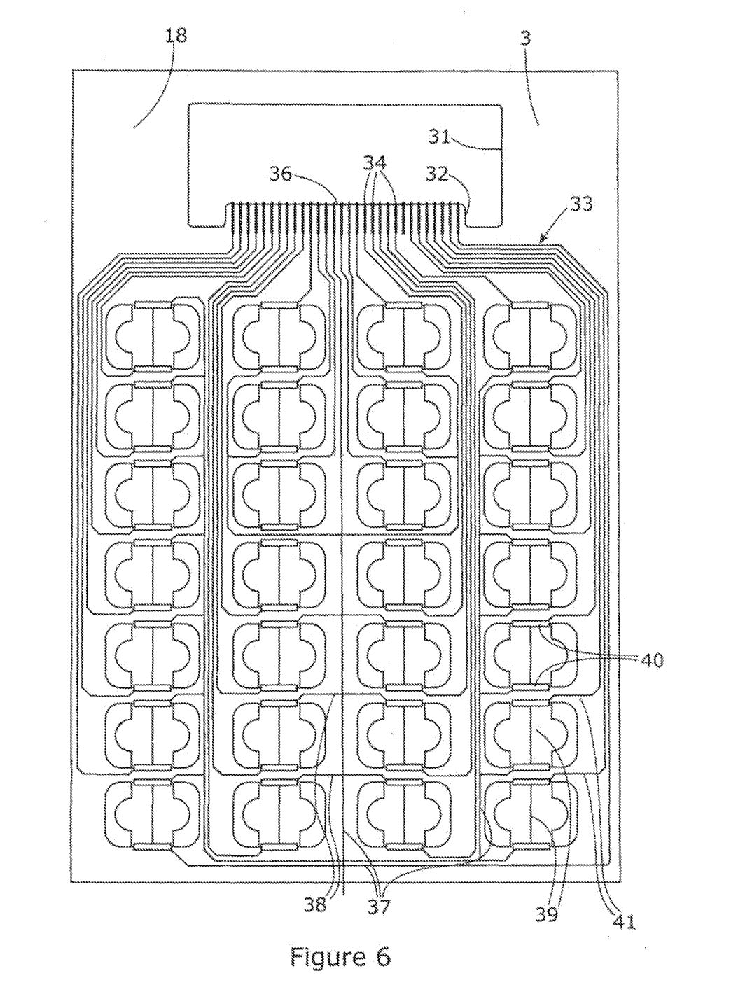

FIG. 7 is an alternative tearable tab for the card of FIG. 1;

FIG. 8 is a further alternative tearable tab for the card of FIG. 1;

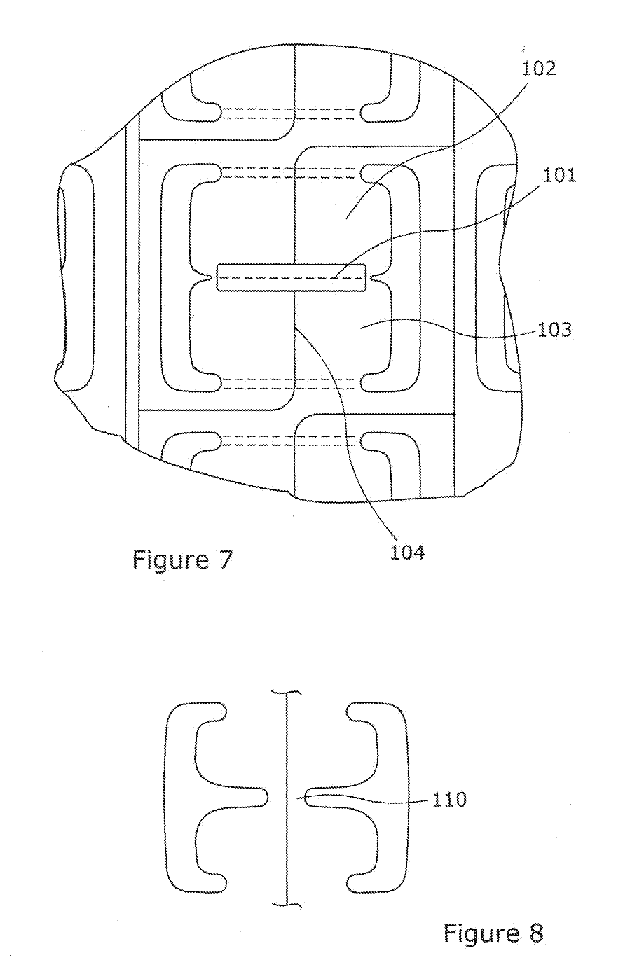

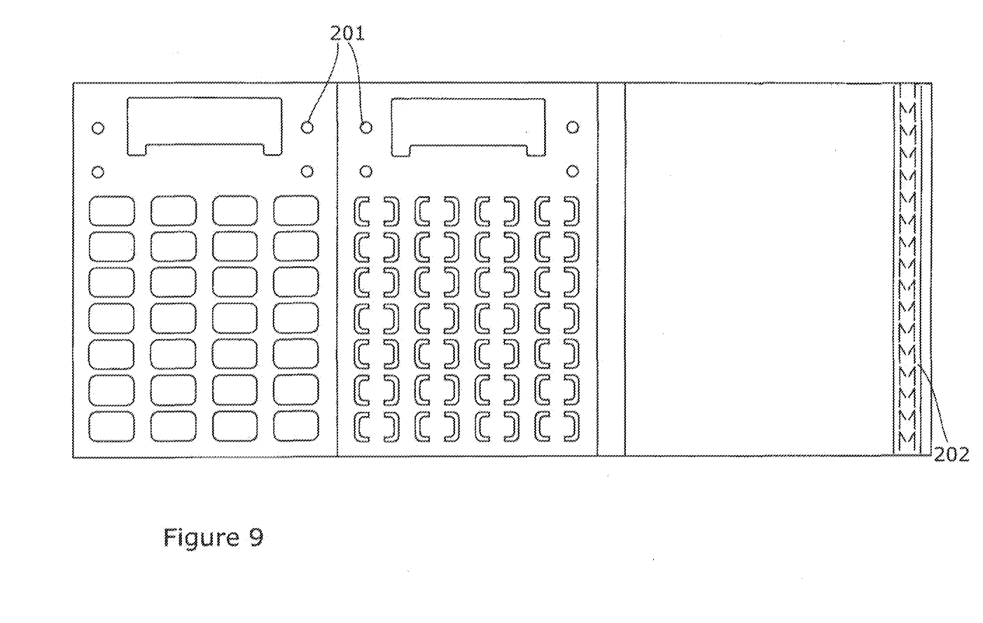

FIG. 9 is a view similar to FIG. 1 of modification of the card of FIG. 1;

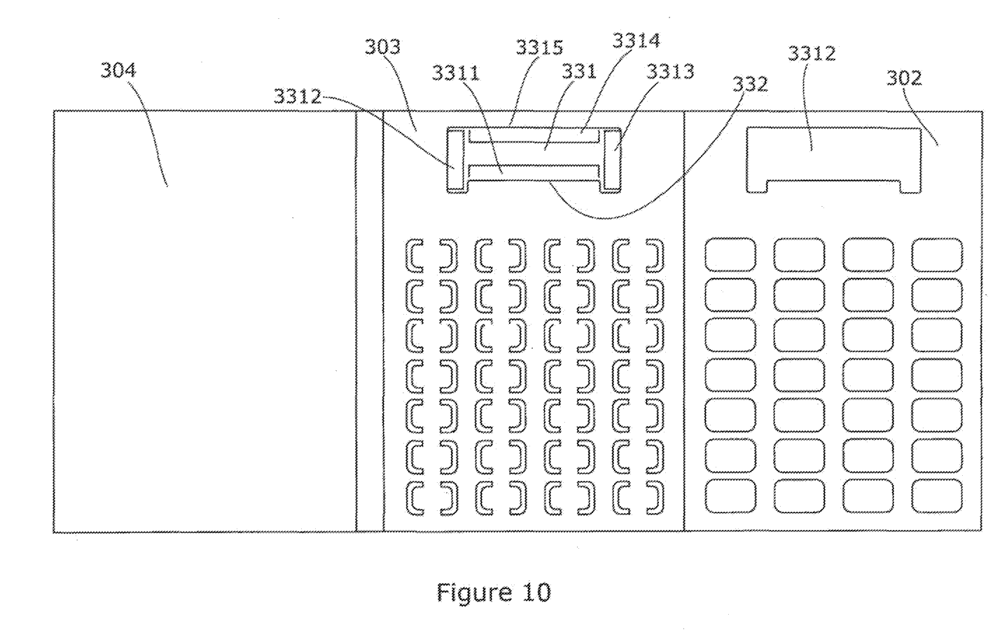

FIG. 10 is a plan view similar to FIG. 1 of another MARS card of the invention;

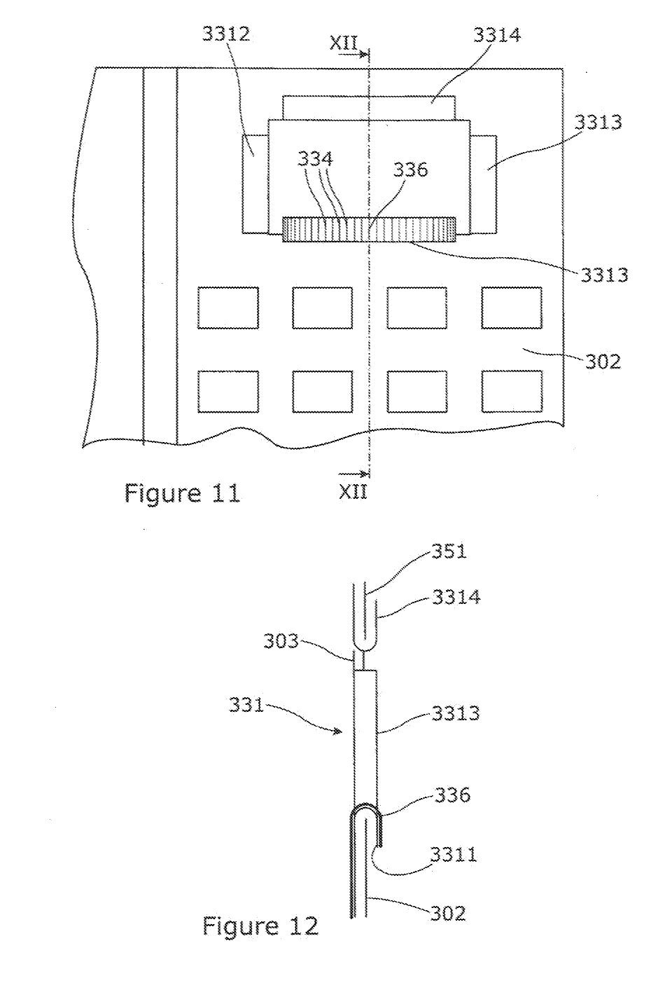

FIG. 11 is a scrap view of the card of FIG. 10 showing tag aperture flaps folded into use position;

FIG. 12 is a cross-sectional view on the line XII-XII of FIG. 11,

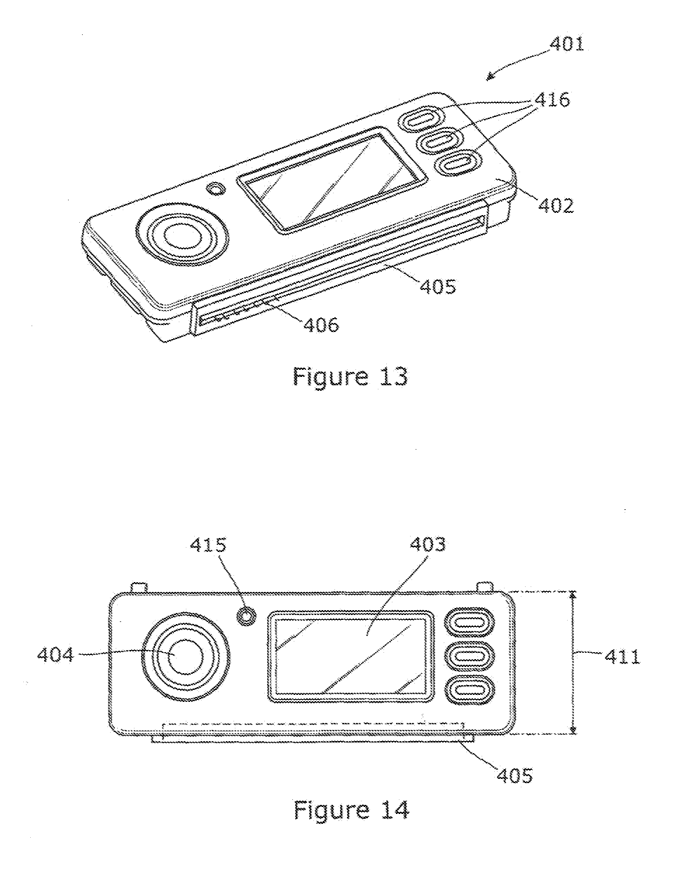

FIG. 13 perspective view of a MARS tag for a pill pack in accordance with the invention;

FIG. 14 is a top view of the MARS tag of FIG. 13;

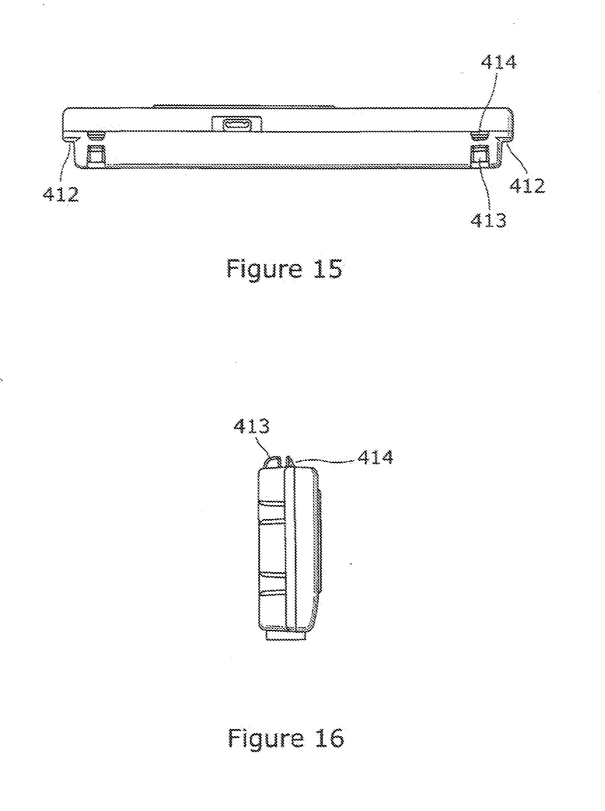

FIG. 15 is as end view of the MARS tag of FIG. 13;

FIG. 16 is a rear view of the MARS tag of FIG. 13;

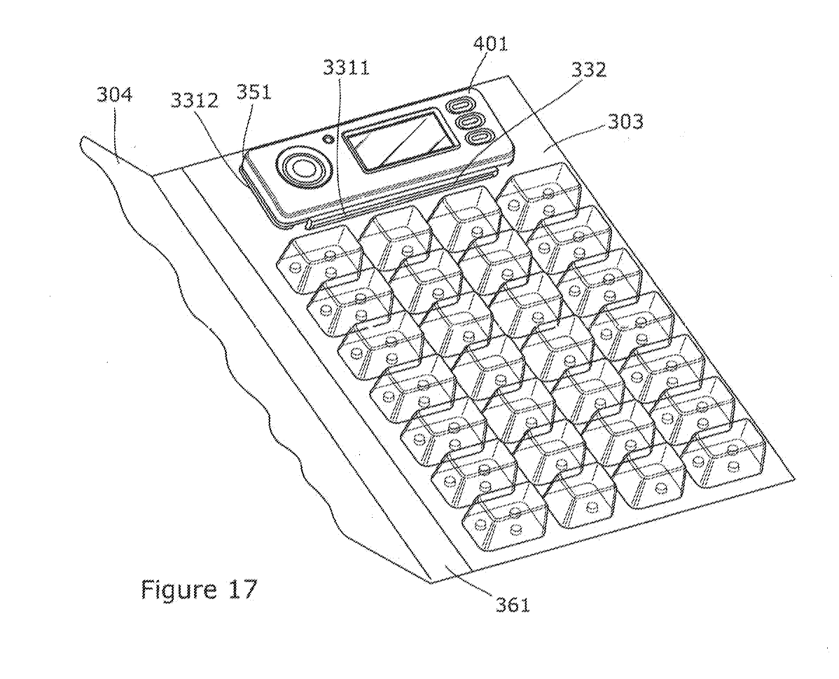

FIG. 17 is a perspective view of the MARS tag of FIG. 13 fitted to the MARS card of FIG. 10;

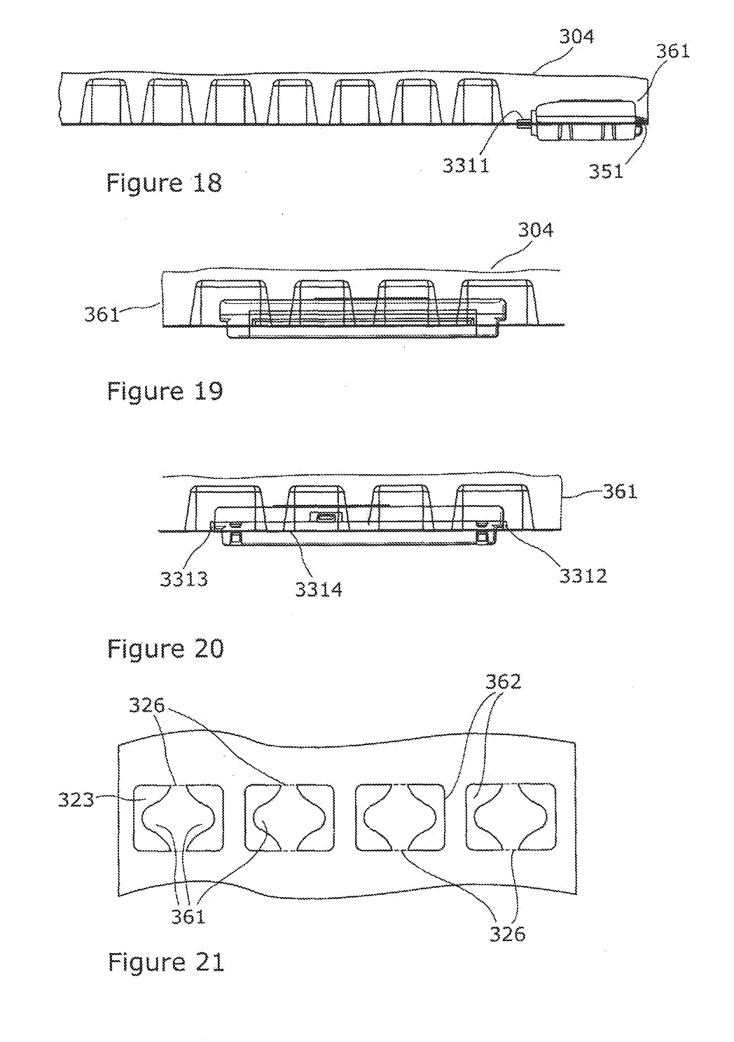

FIG. 18 is a side view of the MARS card and tag of FIG. 17;

FIG. 19 is one end view of the MARS card and tag of FIG. 17;

FIG. 20 is the other is a top view of the MARS tag of FIG. 17; and

FIG. 21 is a scrap view of a line of modified frangible tabs.

Referring to FIGS. 1 to 6, a pill pack card 1 has three pieces 2,3,4 connected by a single fold 5 between pieces 2&3 and a double fold 6,7 between pieces 3&4. In the sense of the folded pack 10 shown in FIG. 5—the inner face 8 of card is coated with adhesive covered with a release paper 9.

The card piece 2 has an array of 28 apertures 10 for the 28 compartments 11 of a vacuum formed tray 12. Its adhesive adheres to the underside of lands 13 between and around the outer edges of the compartments. For use, the release paper is peeled from the piece 2, the tray is adhered in place and populated with pills 14. A closure film 15 is adhered across a complementary array of 28 apertures 16 in the card piece 3 and has adhesive applied to its release paper side. On population the card piece 3 is folded onto the tray, with the film coming into adherence with the lands of the tray. Thus the pills are contained.

The third card piece 5 having adhesive, once the release paper is full peeled off, a prescription sheet 17 can be adhered to the inner face of the card piece 5. This can then be folded over the tray, whose compartments have been inverted by the time that the inner face of the card piece is uppermost for receiving the prescription sheet. The outer face 18 of the card has printing 19, typically high-speed flexo-graphic printing, including an indication of the time of day and days of intended opening of each compartment and taking of the pills.

The apertures 16 in the second, central card piece 3 are not initially complete. They are crossed by respective tabs 21. In the preferred embodiment, these are cut completely from the Y-axis lands 22 between the apertures at their sides, leaving C shaped cut-outs 23. However, they remain connected at their top and bottom portions 24 to the X-axis lands 25. Perforations 26 are provided for ease of tearing of the tabs 21 from the card piece. Conveniently this will be done by supporting the card from below at the lands and pushing the relevant compartment down, rupturing the film sheet at the compartment and tearing the tab, with the pills being ejected into a hand below.

The middle sheet piece 3 has a large rectangular aperture 31 with an up-standing wide tongue 32. The first sheet piece 2 has a corresponding aperture 312. The sheet piece 4 has no such aperture. Printed onto the outer face 18, again typically by high-speed flexo-graphic printing, is a series of conductive lines 33 with a linear series of contacts 34 extending onto the tongue 32. The conductive lines are over printed with background colour 35, typically white, onto which the graphic printing 19 is printed.

The layout of the conductive lines is that a common contact 36 leads to a common lines 37, extending via branches 38 to one or other of the perforated top and bottom portions 24 of each tab. At these portions and indeed the opposite perforated portions the conductive printing is extended to the width of the portions whereby cutting of the perforations does not interrupt electrical conductivity. On each tab, between the wide portions at the perforations, a tab-crossing line section 39 is provided. It has wide ends 40 to ensure conduction prior to tearing of the tab's perforations. Unique lines 41 for each tab extend away from the latter to unique ones of the contacts. The arrangement is that from each tab's unique contact, there is a continuous circuit to the common contact across the tab. Breaking of the circuit, as in breaking of the tab to take the pill's in its compartment breaks the circuit. This can be detected by an interrogatory circuit 42, also referred to as a “MARS tag”, connected to the contacts.

The interrogatory circuit can be housed in a wireless transmitter housed in a case sized to fit in the aperture 31 and receiving the tongue 32 for one for one contact of the contacts 34 with non-shown contacts in the case. The circuit can communicate in any of a number of conventional manners with a remote computer having a MAR database. For instance, the transmitter can be in WiFi contact with a local computer, which interrogates the transmitter regular for a change of state of the circuits in the card. Each time another circuit has been broken this data is relayed for onwards transmission to the remote database. Alternatively, the wireless transmitter can be adapted to transmit every time it detects a newly broken circuit to a mobile telephone having a hardware device adapted to receive the data and relay it on as an SMS message or via the internet to the remote database. Again, the interrogatory circuit may be as simple as a wired connector at the card contacts 34 and a local computer wired to the connector—as by a USB cable—for operation in a manner analogous to that just described.

For correct MAR data recording, there is a requirement not only for data concerning taking of the pills at the right time—assuming that interrogation occurs at least as frequently as the prescribed frequency of pill taking—but also for data concerning the actual person taking the pills. Whilst it is possible for the patient details, such as name and/or health authority registration number, to be input into the interrogatory circuit for transmission with the pill taking data, if is preferred that the interrogatory circuit should transmit only a simple ID No. The ID No can be notified to the MAR database independently, whereby when the database receives data that, for example, Tuesday lunch time's pills have been taken and the ID No is 123,456,789 then the data can be logged as such and any apparent failure to take a prescribed pill can be dealt with in a manner such as exporting the failure data to a care agency having an independent record of the patient's identity.

Nevertheless, the card can be provided with a number of additional interruptible circuits for indicating for instance that a particular interrogator circuit for a particular patient has been fitted to a card containing that patient's pills. For this, a small number of single perforated discs, such as 201 to the sides of the interrogation circuit aperture, are provided. They are able to be pushed out with a pen for instance for interrupting circuits separate from the date and time compartment circuits can be provided.

The interrogator circuits as such can have more contacts than those corresponding to the card contacts, for instance for its programming.

The invention is not intended to be restricted to the details of the above described embodiment. For instance, FIG. 7 shows an alternative two part tab arrangement, in which the tab has a single central perforation 101 between two parts 102,103 that are pushed apart when pills are pushed down between the parts, the tab-crossing line section 104 crossing the perforation. FIG. 8 shows another arrangement where the central perforation is replaced by a necking 110 which can also be torn in a like manner. FIG. 9 shows a tear strip 202 provided down the edge of the third card piece, which can be adhered onto the central piece when the pack is populated and closed to provide a tamper-evidence feature.

Further with reference to FIGS. 10 to 12, the aperture 331 has flaps 3311, 3312, 3313 3314 around its edges, the flaps being connected to the card sheet 303 by creases 3315, which define the shape and size of the aperture. The flap 3311 extends along a tongue 332 which extends along the contact side of the aperture. The contacts 334, including a common contact 336, extend onto the flap 3311 over its crease 3315. They are linear and at right angles to the crease. To either side of the tongue 332/flap 3311, short side flaps 3312,3313 are provided. Opposite the tongue 332/flap 3311 a further flap 3314 as long as the flap 3311 is provided. Initially the flaps obscure the aperture to a large extent.

After population with pills of the compartments 311 of the tray 312 adhered to the card sheet 302, the sheet 303 is folded over the compartments. The sheet 303 already carries the closure film 305, whereby removal of the release paper prior to the folding results in the closure film closing the compartments. The flaps 3311, 3312, 3313, 3314 come to overly the aperture 3312 in the card sheet 302. The flaps, which have their own adhesive revealed by release paper removal, are now folded through the apertures and adhere to the printed side of the sheet 303. Thus the two apertures are edged by triple thickness of card around the greater part of the extent of the sides. This has the effect of reinforcing the particularly at the narrow card strip 351 opposite the tongue and at the tongue, with the contacts extending on both sides of the tongue. The folded over contact portions are aligned with their portions on the card 303. This has the added advantage of the two portions of the contact being spaced by the three card thicknesses for contact with the tag now described. The entire thickness approximates to standard printed circuit board thickness, enabling a standard connector to be used, as described below.

Referring now to FIGS. 13 to 16, a tag 401 for use with the cards of FIGS. 1, 9 & 10, has a body 402, which is rectangular to fit the apertures 32,312; 331,3312. It has a display 403 and an alarm button 404. At one long side it has a connector 405 for putting its contacts 406 into electrical contact with the contacts 34,36; 334,336. Internally it has electrical circuitry, including a memory for its identification, a GSM (Global System for Mobile Communications, originally Groupe Spécial Mobile) communication module and an electrical battery. Externally, it has a display, a buzzer and a panic button. Normally it will be programmed to show the time of day until a particular compartment is due to be opened, such as Wednesday Lunch, for the respective pills to be taken. The buzzer is sounded briefly to alert the user to take the pills. If the compartment is not opened within say 5 minutes, the buzzer will sound again, its timing and frequency being a compromise between battery life and the need to attract the attention of a patient. When the compartment is opened, it is assumed that the pills are taken and the display reverts to the time of day.

The tag's normally communication protocol is to transmit via its GSM module that the compartments for a particular day have all been opened on time, i.e. within say one hour of their intended time. Transmission can be timed to suit reception at a central recording and monitoring station.

If a compartment is not opened on time, a corresponding transmission will normally be made after the lapse of the one hour from the intended time.

If the alarm button is pressed, an instant communication is made, whereby carers can be alerted.

The tag has no manual input for its programming. It can have a unique, factory-set code and be programmed to initiate transmissions corresponding to opening of compartments—or failure to do so—once it is connected to a card of the invention. Alternatively, it can be programmed by connection to a programming unit (not shown) which switches the tag to programming mode via a unique set of open and closed contacts in the programming unit. In programming mode, the GSM unit is able to receive data, such as a patient identifying code and name, enabling the display to show the patient's name. Other data can be for instance to not send non-opening transmissions nor to sound the buzzer at lunch time, where for instance the patient's medication includes no lunch time pill.

Programming of the tag to transmit only, specifically (i.) to confirm compliance (ii.) to alert to non-compliance and (iii.) to alarm, as opposed to transmit in response to interrogation is more efficient in terms of battery life.

The body has further features:
A defined distance 411 between the bottom of its connector 405 limiting the extent to which the tongue 32; 332 can be inserted into the connector and the opposite side of the aperture, whereby the tag is restrained in position with the respective contacts in contact;
Steps 412 at both ends for aligning the tag with the card. The method of connection being that the tag is offered up to the card from the side of the central sheet 3; 303 having the compartments, i.e. opposite from the side having the tabs 21; 321. The tongue 32; 332 is aligned with the orifice of the connector 405. In this position, the underside of the tag at its opposite side rests on the narrow strip 351 of the sheet at the opposite side of the aperture. As the tag is urged towards the centre of the sheet, where the tabs are, the tongue passes into the connector and the tag can be pivoted down to lie parallel with the sheet with the steps 412 resting on the sheet;
Resilient latches 413 are provided at the opposite side of the body, which are angled to cause them to move into the body as they engage with the opposite strip 351 and which spring out under the strip once the tag is in position. Small stops 414 are provided above the latches to abut the top of the strip, with the latches sprung out below.

As shown the tag can incorporate additional features:
An LED 415 to be illuminated at the same time as the buzzer to provide visual alert to the time to open a compartment. The tag can also be programmed to indicate via flashing and extinction of the LED that the tag has been correctly connected to the card and all the expected tab-crossing circuits are conducting;
A set of buttons 416 for additional MARS input. For instance the patients medication regime may include topical creams and/or liquid medicines. The tag is programmed with the timing of these and alerts to their timing. The patient can acknowledge administration/taking via the buttons in conjunction with prompts on the display. Another envisaged use of the buttons is to enable a carer to log adverse reactions to the pills, such as vomiting, and/or patient refusal to take the pills.

As shown, the card is arranged for the compartments to extend from the side of the card corresponding to the display side of the tag. The third sheet of the 304 of the card is connected to the central sheet 303 by a spine 361 spacing the sheets, whereby the third covering sheet can overlie the ends of the compartments 311, their ends being spaced from the surface of the sheets 303,304 sandwiching the cover film and the lands of the tray having the compartments 311. With this arrangement, the pills are dispensed by pressing on the compartments to rupture the cover film and the tabs in the sheet 303. If the card is not well supported during this dispensing, it can be damaged.

To ameliorate this the arrangement can be varied to have the tabs on the tag display side of the sandwich, normally covered by the third sheet. This requires for the tabs to be broken for pill dispensing. This can be eased by forming the tabs with lateral noses 361, extending close to the sides 362 of the compartments. In other words the cut-outs 323 are tapered to narrow extent at mid-way between upper and lower perforations 326. For opening of a compartment, one or both of the noses can be pushed into the compartment, rupturing the sealing film and a finger hooked beneath a central portion of the tab. This can then be pulled up for pill dispensing. This is less damaging for the card as a whole.

An additional feature is that the outer compartments for breakfast and night time pills are larger than the lunch and tea time compartments, to contain more pills as shown in FIG. 17, because most medication regimes involve more pills in the morning and evening than during the middle of the day.

1. A card for a MARS pill pack and tag, the card comprising:
a cut-out open to an edge of the card or an aperture spaced from edges of the card for receiving the tag, with contacts arrayed at one side at least of the cut-out or aperture; and
at least one formation in the card at at least one other side of the cut out or a tag backing strip extending at a side of the aperture opposite from the one side, the formation(s) or the tag backing strip being provided to hold the tag against movement parallel to the card whereby tag contacts are retained in contact with the card contacts in use.

2. A card for a MARS pill pack and tag as claimed in claim 1, wherein the card contacts are provided at one side only of the cut-out or at one side only of the aperture.

3. A card for a MARS pill pack and tag as claimed in claim 1, one or more auxiliary contacts at other sides of the cut-out or aperture.

4. A card for a MARS pill pack and tag as claimed in claim 1, wherein a cut-out open to an edge and side formations are provided, the cut-out having at least one lateral dimension at one position spaced from the edge of the card, which is narrower than a lateral dimension at another position spaced further from the edge of the card, forming an overhung feature.

5. A card for a MARS pill pack and tag as claimed in claim 4, for use with a tag formed with complementary feature(s) whereby it is held onto the card, the card formation(s) being resilient for deformation and return to shape into the tag feature(s).

6. A card for a MARS pill pack and tag as claimed in claim 1, wherein an aperture spaced from edges of the card and a tag backing strip are provided, wherein the tag backing strip also has a double folded flap, and preferably the aperture is rectangular and the other two sides of the aperture also have double folded flaps.

7. A card for a MARS pill pack and tag as claimed in claim 1, further comprising a flap folded double at the side(s) having the contacts.

8. A card for a MARS pill pack and tag as claimed in claim 1, wherein the card itself is folded double to be adhered not only to the sealing film but also as a backing sheet to the tray on the side thereof opposite from the sealing film, with the compartments extending through cut-outs in the backing sheet portion of the card.

9. A card for a MARS pill pack and tag as claimed in claim 8, wherein the folded double flaps are folded onto, and adhered onto, the backing sheet, whereby three thicknesses of card are present at the extent of the folded double flaps.

10. A card for a MARS pill pack and tag as claimed in claim 1, wherein the card is preferably of a thickness commonly referred to as card.

11. A card for a MARS pill pack and tag as claimed in claim 1, wherein the contacts extend to an edge of the card or its aperture as a linear series.

12. A card for a MARS pill pack and tag as claimed in claim 1, wherein the card or aperture edge having the contacts has a pair of positioning features for determining the relative position of a tag connector to the contacts to ensure one for one contact of the card contacts with tag contacts in the connector.

13. A card for a MARS pill pack and tag as claimed in claim 1, wherein one of the lines for each tab of the card is connected in common to a single common contact and the other line and its contact is unique to each tab, and the lines are preferably arrayed symmetrically with respect to a central, common return line.

14. A card for a MARS pill pack and tag as claimed in claim 1, including other conductive lines and respective contacts for other openable contacts in the card.

15. A card for a MARS pill pack and tag as claimed in claim 1, wherein tabs of the card are provided with one or more narrow portions and/or partially cut through and/or perforated portion(s) at adjacent parts of the card.

16. A card for a MARS pill pack and tag as claimed in claim 15, wherein the tabs have lateral noses, extending close to sides of their compartments.

17. A card for a MARS pill pack and tag as claimed in claim 1, wherein tabs of the card are two part with a narrowing or partially cut or perforated portion between the parts.

18. A card for a MARS pill pack and tag as claimed in claim 1, wherein compartment closure film is pre-applied to the card across its apertures and its tabs.

19. A card for a MARS pill pack and tag as claimed in claim 18, wherein a third piece of card is connected to the tabbed piece at an edge opposite from the compartment receiving piece.

20. A tag for a MARS pill pack and tag, the tag comprising:
a one side having complementary contacts arranged along it; and
an opposite side spaced from the one side for abutment against a backing strip of the card with its contacts connected to the complementary contacts or
another side formed with a formation complementary with a formation of the card for engagement therewith with its contacts connected to the complementary contacts.

21. A tag for a MARS pill pack and tag as claimed in claim 20, wherein the opposite side and/or one or both other sides of the tag is/are stepped and/or have formations for locating against face of the card at the aperture.

22. A tag for a MARS pill pack and tag as claimed in claim 20, wherein the tag has at least one sprung latch arranged at and movable inwards of the opposite side and/or one or both other sides of the tag on fitting to the tag to the card and to spring out on opposite side to the card from the tag formation.

23. A tag for a MARS pill pack and tag as claimed in claim 20, wherein the tag is adapted to be programmed to display the identity of the next compartment to be opened in use and preferably the identity of additional medicament to be taken in addition to pills within compartments of the pill pack.

24. A MARS pill pack combination of:
a card comprising:
a cut-out open to an edge of the card or an aperture spaced from edges of the card for receiving the tag, with contacts arrayed at one side at least of the cut-out or aperture; and
at least one formation in the card at at least one other side of the cut out or a tag backing strip extending at a side of the aperture opposite from the one side, the formation(s) or the tag backing strip being provided to hold the tag against movement parallel to the card whereby tag contacts are retained in contact with the card contacts in use,
a tray having an array of pill compartments; and
a film for sealing the compartments.

25. (canceled)
